(19) United States
(12) Patent Application Publication
(10) Pub. No.: US 2026/0103598 A1
(43) Pub. Date: Apr. 16, 2026

(54) ASPHALTITE-BASED ADDUCTS AND POLYMERS, METHODS OF MAKING AND USING THE SAME, AND PRODUCTS USING THE SAME

(71) Applicant: Asphalt Systems, Inc., Salt Lake City, UT (US)

(72) Inventor: Joseph LARUSSO, Oro Valley, AZ (US)

(21) Appl. No.: 19/419,833

(22) Filed: Dec. 15, 2025

Related U.S. Application Data
(63) Continuation-in-part of application No. PCT/US2024/061375, filed on Dec. 20, 2024.
(60) Provisional application No. 63/612,644, filed on Dec. 20, 2023.

(51) Int. Cl. C08L 95/00; E01C 7/30; E01C 7/35; E01C 19/18

(52) U.S. Cl. CPC C08L 95/005; E01C 7/30; E01C 7/358; E01C 19/182; C08L 2201/52; C08L 2205/025; C08L 2205/035; C08L 2207/22; C08L 2207/24; C08L 2555/22; C08L 2555/34; C08L 2555/50; C08L 2555/86

(57) ABSTRACT

Described herein are asphaltite-based adducts and polymers and methods of making the same. Asphaltite may be modified with a reagent such as polyphosphoric acid. The reagent may modify the asphaltite or portions or moieties thereof to possess a positive charge. The reagent may also activate the asphaltite or portions thereof to enable epoxy and/or urethane polymerization reactions within the asphaltite or portions thereof, and/or to enable cross-linking of the asphaltite-based polymers or adducts. Products incorporating asphaltite-based polymers and adducts are also described.

### CROSS-REFERENCE TO RELATED APPLICATION

This application is a continuation-in-part of International Application No. PCT/US2024/061375, which was filed on Dec. 20, 2024 and which claims priority to U.S. Provisional Application Ser. No. 63/612,644 filed on Dec. 20, 2023. The contents of these applications are herein incorporated by reference.

### TECHNICAL FIELD

The present disclosure relates to asphaltite-based adducts, asphaltite-based polymers, methods of making asphaltite-based adducts or polymers, methods of using asphaltite-based adducts or polymers, and products incorporating asphaltite-based adducts or polymers.

### BACKGROUND

Asphalt binder is a chemically complex composition. Generally, asphalt binder includes asphalt cement (e.g., bitumen) as the continuous phase. Asphalt cement or bitumen is a well-defined crude-oil refining product (e.g. vacuum tower bottoms) comprising sometimes hundreds (and possibly thousands) of different chemical compounds and molecules in a colloidal dispersion. The bitumen is often blended with other additives such as polymers to provide enhanced properties in specific applications, including paving, roofing, and more. The type of bitumen or asphalt cement, or the type of additives, may vary depending on the intended application.

As a colloidal system, asphalt cement includes various constituent components. For example, asphalt cement may include chemically distinct fractions of components (or types of components). One common way to analyze an asphalt cement is by reference to the saturates, asphaltenes, resins, and aromatics (SARA) fractions of the asphalt cement. Saturates are the most hydrophobic of the SARA fractions that are typically oily or waxy components, the least polar of the SARA fractions with the aromatic fractions being higher on the polar scale. Resins include even more polar components, with the asphaltenes being the most polar of the fractions. Other compounds and molecules may also exist within the asphalt cement. The proportions of the SARA fractions impact the overall colloidal system, and thus the characteristics and performance of the asphalt cement. Often, hard asphaltenes are surrounded and solvated by the aromatics, resins, and saturates in a colloidal system structure.

In the paving arts, asphalt cements and binders with a particular rheological and aging profile are preferred. Specified tests are employed to categorize asphalt cements and binders useful for paving, such as the SuperPave pavement grading system that categorize different asphalts according to their native and aged properties across a range of temperatures and applied stresses and strains. Asphalt cements and binders useful for paving tend to have favorable rheological and aging characteristics at a range of temperatures specific to the local area in which the asphalt is being used.

Asphalt pavement is a composite material placed at elevated temperatures that includes mineral aggregate and an asphalt binder which hardens during cooling to form a robust structural material and surface. Asphalt pavement deteriorates over time from oxidation of the asphalt binder, heavy loads, varying climatic conditions, moisture infiltration, and other aspects affecting binder ageing and deterioration. Asphalt binders are also often used as a waterproofing and binding compound for pavements constructed on metal or concrete decking, such as bridges and elevated roadways, and the asphalt binder in such applications suffers from similar deterioration phenomena as with an asphalt pavement. Similarly, asphalt-based roof coatings and products are engineered for those applications, with the asphalt binders typically hardened and stiffened to forestall the expected asphalt deterioration phenomena via exposure to harsh conditions. Asphalt binders are also found in applications such as industrial coatings for metals, concrete, and other substrates.

One known way of mitigating asphalt deterioration due to ageing and oxidation is to alter the properties of the asphalt composition with additives. The type and quantity of additives depends on the expected end-use for the asphalt. A known way to mitigate asphalt deterioration is to add specific polymers to the asphalt composition. Additives like elastomerics or acrylic polymers may improve the final performance characteristics of the end product, such as asphalt pavement. However, such additives may be difficult to work with and may make certain asphalt products more difficult to manufacture, store, or use.

Certain polymer additives in specific configurations and dosages are relatively compatible with the asphalt cement. Such polymer additives may impart beneficial thermo-elastomeric properties to the asphalt binder, such as elasticity, durability, anti-ageing properties, and other beneficial or desired qualities. Polymer additives may include SBS (styrene butadiene styrene), SBR (styrene butadiene rubber), EVA (ethylene vinyl acetate), recycled tire rubber (a/k/a “crumb rubber”), and others. These polymers and their interactions with asphalt cements and binders have appeared over time in industry standards and specifications, manufacturing processes, uses, and testing methods, including the SuperPave performance grading system and those published by the American Society of Testing and Materials (ASTM) and the American Association of State Highway and Transportation Officials (AASHTO). Similarly, polymer additives such as SBS, SEBS (styrene ethylene butadiene styrene), EPDM (ethylene propylene diene monomer), and the like have been used in the asphalt roofing industry, and polymer additives have been used in the industrial asphalt coatings industry.

Polymer additives have known limitations and drawbacks, and improvements are being investigated. For example, many polymer additives are difficult to mix with asphalt cement due to chemical incompatibility and viscosity increases. Some polymer additives may cause asphalt emulsions to become unstable, which can lead to coagulation or premature breaking. Others require the use of alternative surfactants, which can unfavorably decrease the viscosity of the emulsion or lengthen the break and cure time of the emulsion when applied. Others require elevated use levels of surfactant, which can have similar unfavorable effects. Elevated surfactant levels may also lead to surfactant retention on the asphalt residue and pavement. This may lead to partial re-emulsification during a heavy rainfall and cause the asphalt residue to separate from the pavement.

Other known polymer modifiers for asphalt binders exist with thermoplastic or thermoset characteristics utilizing the introduction of multicomponent epoxy compounds or multicomponent urethane compounds into the asphalt cement, wherein every component of the epoxy or urethane must be separately added to the asphalt system. These compositions and systems may be complex with limitations and drawbacks. For example, multicomponent urethane compounds are typically introduced into an asphalt composition via individual compounds to form reactive or reacted compositions. This requires the presence of both an added isocyanate (often a methylene diphenyl diisocyanate or MDI), an added polyol resin, often a dissolved elastomeric polymer (e.g. SBS), and an activator proceeding to react, cross-link, and network via carbamate intermediates. Applied heat is usually required. Similarly, epoxy-type compounds utilize introduced variants of epoxide esters and resins, which typically cross-link via an activator, all of which need to be separately added to the system.

Another example of an asphalt binder additive is gilsonite (which is also known as uintaite). Gilsonite is a naturally occurring asphaltite hydrocarbon mineral resin. Gilsonite has a unique composition that has various molecules that act in asphalt compositions in a number of different ways. Gilsonite is relatively high in asphaltenes and polar resins and provides excellent chemical compatibility with asphalt cement. Gilsonite is known to disperse completely and uniformly into the continuous asphalt cement phase of most asphalt cements having an 80 penetration grade or higher, at add rates up to 30% by weight, creating a single-phase gilsonite-modified asphalt cement composition. Gilsonite can thus solvate into asphalt cement in predictable ways. When blended with asphalt cement, the gilsonite and asphalt cement become fully integrated into a continuous asphalt blend composition. Gilsonite also establishes a more uniform spectrum to the colloidal balance of the asphalt composition. The properties of gilsonite balance well with the properties of asphalt cement typically available. Enhancements observed on adding gilsonite to asphalt cement include a lower penetration grade, a higher softening point, increased elastomeric and ductile properties, enhanced durability, decreased water sensitivity, and increased anti-aging properties.

Gilsonite is a type of mineral known as an asphaltite. Gilsonite, or uintaite, originates specifically in the Uintah Basin in Utah and Colorado. Other asphaltite sources exist. For example, natural asphaltites can be found in Iran and Colombia. Other asphaltites include glance pitch or manjak from Barbados and grahamite from West Virgina, Oklahoma, Cuba, and Mexico. Asphaltites are generally hard, solid bitumen minerals.

Gilsonite has a relatively high nitrogen content, especially compared with petroleum-derived asphalt cements and binders and other asphaltites. The nitrogen is commonly present as a pyrrole (which is a polar resin), so adding gilsonite to asphalt cement increases the fractions of polar molecules in the combined asphalt cement and gilsonite blended composition, based on a SARA fraction analysis. Moreover, nitrogen-containing pyrroles in gilsonite may also be present in linked, scaffold-like structures, similar to porphine or porphyrins such as heme. Because gilsonite includes a higher proportion of nitrogen polar resins such as pyrroles, and pyrroles are considered non-toxic, gilsonite is considered environmentally beneficial. It has been deduced that phenols, pyridines, and pyrroles are common in the molecules comprising gilsonite. Most of the nitrogen is expected to be within pyrrole rings. Further, it is believed that the aromatic rings are highly substituted with alkyl chains, and that such alkyl chains may connect other aromatic rings, including pyrroles. FIG. 1 provides an illustration of the macrostructure of a typical portion of gilsonite based on the foregoing data. Other asphaltites are believed to contain some degree of similar nitrogen-containing chemical structures, including phenols, pyridines, pyrroles, and porphyrin-like structures.

Gilsonite is also known to contain metals. Table 1 below provides approximate metal content of gilsonite as measured by x-ray fluorescence spectroscopy. It is believed that pyrroles in gilsonite (and other similar molecules in gilsonite including pyrrole complexes and porphyrins) contain or otherwise associate with one or more of these metals. It is suspected that the same associations occur in other asphaltites as well.

TABLE 1
Approximate Metal Content of Gilsonite

| Metal | Approx. Max. ppm |
|---|---|
| Na | 500 |
| Mg | 200 |
| Al | 550 |
| Si | 1600 |
| Ca | 350 |
| Cu | 1 |
| Fe | 450 |
| Mo | 11 |
| Zn | 15 |

Additives are known to interact with the colloidal system of asphalt compositions. In theory, it may be beneficial to introduce additives to enable reactivity with some of the asphalt molecules or crosslinking of portions of such to increase failure strength, elasticity, or other properties of asphalt when applied to pavement. When multi-component additives are added to asphalt cement, the possibility of any one component interacting and/or reacting with other components of the system is likely and is generally undesirable, as such activity may interrupt, interfere with, or otherwise confound the intended functionality of those other components and decrease the overall performance of the system. For example, while certain additives may improve the elastic modulus or the failure strength of an asphalt binder in the pavement, the same additives may hinder performance in high-temperature environments and may render the pavement more sensitive or susceptible to moisture damage. Further, whether a multi-component additive would even be compatible as a whole with an asphalt cement or emulsion thereof, or would provide any desired elasticity or strength in the resultant binder composition is difficult to predict and is largely an impractical trial-and-error exercise. With numerous types of asphalts, and a plethora of different possible multi-component additives, the task of identifying a compatible additive becomes extremely burdensome, and optimizing multiple additives becomes a significant challenge.

Further still, additives such as polymers, or multi-component additives such as urethanes and epoxies, can be dispersed into asphalt, but such additives will retain inherent properties which are different than the asphalt into which it is dispersed. For example, both polymers and asphalt cement may have different glass transition temperatures resulting in compositions that do not have an ideal or uniform performance. Additives may react with components of the asphalt cement, and how the mixture responds is difficult to predict and control. As a result, such mixtures are prone to either premature or untimely delinquent setting in storage, during transportation, and during application, which disrupts the usefulness of the materials as well as tanks, applicators, and related equipment.

It would be desirable to obtain functionality of an additive, and especially a multi-component additive system, via a component that decreases the likelihood of unfavorable interactions of the additives with the continuous asphalt colloidal system and increases the likelihood of increased compatibility of the additives in the resultant system's composition.

### OVERVIEW OF THE DISCLOSURE

One aspect of the disclosure provides an asphalt composition that includes a blend of an asphalt binder, an asphaltite, and a polymer; and an acid that is at least one of a strong acid or a multiprotic acid. The acid may cause polar resins in the asphaltite to be in an excited protonated state. The polymer may be an alkene, ester, carbonyl, or alcohol moiety, or a urethane or an epoxy. The polymer may be incorporated into the asphalt binder and the asphaltite such that the blend has a continuous, amorphous phase. The blend may exhibit at least one change to a rheological property compared to the asphalt binder and the asphaltite alone. The asphalt composition may include a rheological modifier such as a Fischer Tropsch wax. Some of the polar resins in the asphaltite may cross-link or polymerize with the polymer. An example acid is polyphosphoric acid. When polyphosphoric acid is used, the acid may also cross-link or polymerize with the asphaltite and the polymer. Optionally, an isocyanate may be added to the asphalt composition. An asphalt composition may exhibit an increase in stiffness and an increase in elasticity compared to the asphalt binder and the asphaltite alone.

Other aspects include a method of making the foregoing asphalt composition. The asphalt composition may be useful in making a pavement from a hot mix asphalt, a warm mix asphalt, or a cold mix asphalt such as a cold mix recycled asphalt pavement. Asphalt compositions may be useful in making or conducting a warm spray surface treatment, which can be made and used in a cutback or emulsion form.

### BRIEF DESCRIPTION OF THE DRAWINGS

The foregoing summary, as well as the following detailed description of illustrative embodiments of the present application, will be better understood when read in conjunction with the appended drawings. For purposes of illustrating the present application, there is shown in the drawings illustrative embodiments of the disclosure. It should be understood, however, that the application is not limited to the precise arrangements and instrumentalities shown. In the drawings:

FIG. 1 is an example diagram illustrating a simplified view of an example molecular macro-structure contained in gilsonite and also believed to be contained in other asphaltites.

FIG. 2 is an example reaction of a pyrrole reacting with a ketone in the presence of an acid to form a porphyrinogen, which may be further oxidized to form a porphyrin.

FIG. 3 depicts example oxygen-containing and nitrogen-containing molecules believed to be present in gilsonite and other asphaltites.

FIG. 4 is a table comparing the performance of several gilsonite-asphalt compositions in comparison with one embodiment of an inventive blend (Sample 7) to illustrate surprising changes in properties compared to Blends 1-6.

FIG. 5A shows a graph of the MSCR (multiple stress creep recovery) parameter measured at 76° C. overlaid with the FTIR signal in the range of 1100 cm-1 for samples 3-5 and 7.

FIG. 5B shows a graph of the MSCR parameter measured at 76° C. overlaid with the FTIR signal in the range of 1100 cm-1 for samples 6 and 7.

### DETAILED DISCLOSURE

The present disclosure relates to asphaltite-based adducts and polymers, methods of making asphaltite-based adducts and polymers, and products containing asphaltite-based adducts and polymers. Specific example aspects of the present disclosure include modifying an asphaltite or portion(s) of asphaltite (such as pyrroles, porphyrins, and/or other polar resins) with a modifier such as acid (including, e.g., polyphosphoric acid). In additional or alternative specific example aspects of the present disclosure, polar resins of asphaltite (such as pyrroles, porphyrins, and the like), become activated and are available for further reaction. In additional or alternative specific example aspects of the present disclosure, asphaltite containing polar resins are utilized to form new covalent bonds or molecular interactions, including adducts, dimers, and polymers, and/or may induce cross-links. In additional or alternative specific example aspects of the present disclosure, asphaltite containing polar resins is combined with an activator (such as polyphosphoric acid), one or more cross-linking agents, or polymer containing alkene, ester, carbonyl, alcohol, urethane, epoxy or other reactive moieties (such as crumb rubber, SBS, SBR, vinyl acetate, or methacrylate). The resulting composition, which is demonstrated with gilsonite as the asphaltite, is unique and surprisingly exhibits transformational characteristics and properties.

Benefits of systems according to the present disclosure include making improved asphalt compositions via a modified asphalt cement binder that is tunable in the sense that the performance characteristics of the modified asphalt binder composition can be manipulated as desired by varying the amount of asphaltite and other reactants and reacting them in a manner that was previously unpredictable and unknown. By reacting certain moieties naturally present in asphaltite with acids and other activators, these moieties in asphaltite covalently bond, cross-link, polymerize, with the asphalt cement binder and other additives (monomers, polymers, cross-linking reagents, etc.) and draws these additives into a continuous phase with the asphalt and asphaltite mixture. The result is an adjustable asphalt composition that may be tuned to exhibit certain desired rheological and performance characteristics, increased use of recycled additives and aggregates, and others that may become apparent to those of skill in the art.

Compositions according to the present disclosure may have applications in paving, roofing, soil stabilization; waterproofing; sound insulation; oil and gas extraction; coatings of brick, concrete, and metals; pipe coatings; industrial coatings; and industrial composites. Paving applications may include cold sprays (both emulsions and cutbacks), hot and warm sealcoats, flexible interlocking layers, fog seals (including preservation fog seals and rejuvenating fog seals), sand seals, scrub seals, stress absorbing membrane interlayer (SAMI) seals, waterproofing seals, texture seals, surface dressings, cold recycling (including Cold Central Plant Recycling, Cold In-place Recycling, any emulsion method, as well as foamed method), hot in place recycling, full-depth reclamation, Hot Mix Asphalt (HMA), and Warm Mix Asphalt (WMA), including Pervious and/or Permeable Pavement, Porous Friction Course, Open Graded Friction Course, and the like. In examples, asphaltite-based adducts or polymers may be incorporated into pavement applications and products, used in pavement mixes as well as surface treatments including preserving new asphalt pavements, restoring and rejuvenating aged asphalt pavements, rejuvenating crack fillers, and adding positive texture to cracked, oxidized, or deteriorated asphalt pavements and maintaining, repairing, and rehabilitation or reconstruction of pavements, and waterproofing concrete and metal decks for pavements. Additional examples include incorporating asphaltite-based adducts or polymers into paints or powder coatings.

Compositions made according to the present disclosure may provide significant benefits, especially in the paving arts. Such compositions may exhibit anti-aging characteristics, allow for the use of economical and generally available recycled polymer materials (such as tire rubber, high-density polyethylene, EPDM rubber, and the like) as opposed to expensive specialty polymers, allow for the use of less additives to meet minimum pavement specification, allow for the use of more additives than was previously practical to attain significantly higher performance characteristics, allow for a multi-stream application to increase the storability of the reactants and delay a reaction until present at a job site, and others. Compositions according to the present disclosure may be highly stable without the need for binder stabilizing agents.

Asphaltites are unique compositions containing a combination of various molecules that act complementarily in asphalt compositions in a number of different ways. Gilsonite in particular has high asphaltene content, high solubility in organic solvents, high purity and consistent properties, high molecular weight, and high nitrogen content. Gilsonite typically has the following elemental composition:

TABLE 2
Elemental Composition of Gilsonite

| Element | Approximate Percentage |
|---|---|
| Carbon | 84.9 |
| Hydrogen | 10.0 |
| Nitrogen | 3.3 |
| Sulfur | 0.3 |
| Oxygen | 1.4 |
| Trace Elements | 0.1 |
| Aliphatic Carbon | 68.3 (Percent of total Carbon) |
| Aromatic Carbon | 31.7 (Percent of total Carbon) |

Asphaltites have chemical structures and chemical reactivities similar to many constituents of asphalt cements and binders, thus, asphaltites are compatible with and soluble into asphalt cement compositions.

Asphaltites may contain aliphatic carbon chains connecting high-molecular-weight clusters of carbon-ring groups. Asphaltites may have a relatively high polar-resin fraction containing cyclic and/or aromatic nitrogen, in pyrroles and similar molecular configurations (such as pyridines, amide functional groups, and porphyrin-like structures). Additionally, it has been discovered that phenolic and carbonyl functional groups are also present in gilsonite, and they may also be present in other asphaltites. The oxygen content relative to the nitrogen content indicates that the nitrogen has basic functionality. As such, asphaltites, when in specific chemical environments, including when solvated into asphalt cement, can potentially react with other molecules within the asphaltite itself as well as with molecules from asphalt cement or additives. Thus, certain molecular associations, electrostatic interactions, complexations, bridging, reactions, and polymerizations and cross-linking that significantly alter the properties of the asphaltite and asphalt-cement compositions and which are beneficial to performance of the asphaltite and asphalt-cement compositions, can be realized. For example, as a surface treatment or pavement binder, improvements may include aspects of durability, flexibility, anti-aging, lower application temperature, and the like.

The average molecular weight of gilsonite is 3,000, which is high relative to most asphalt products and to most synthetic resins. Other asphaltites may have a comparable molecular weight. Gilsonite, and it is believed other asphaltites, may display semi-polymeric behavior when used as a modifying resin, including in asphaltic polymeric and elastomeric systems. Additional reactivity may be realized, including cross-linking and addition-type reactions, when portions of asphaltites react with compounds such as ketones, aldehydes, alcohols, esters, ethers, urethanes, epoxies, and carboxylic acids.

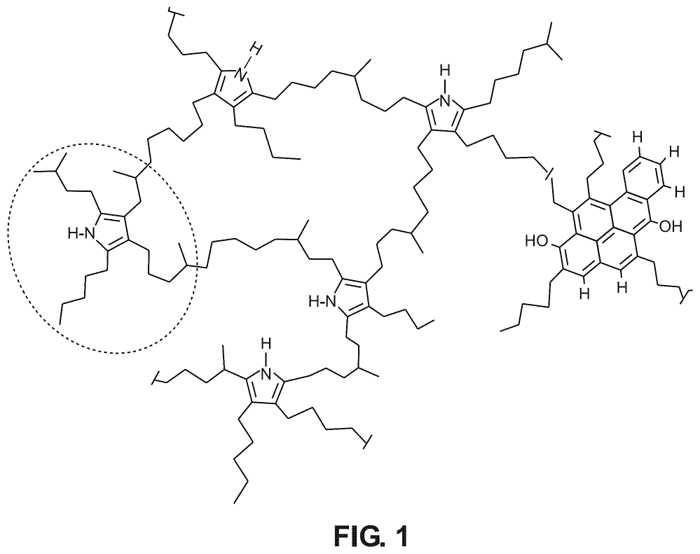

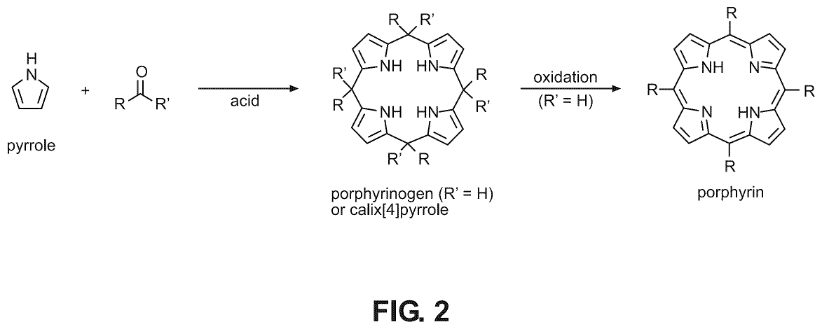

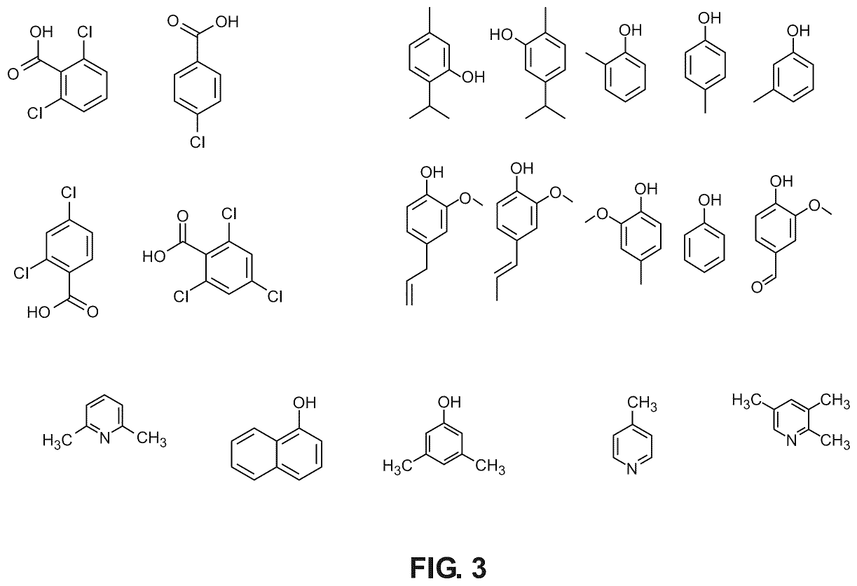

FIG. 1 is an example diagram illustrating a representative view of an example molecular macro-structure contained in gilsonite and believed to be contained in other asphaltites (although it should be recognized that other moieties, arrangements, and structures may and likely do exist). Relative to asphalt cement, asphaltites contain a relatively high nitrogen content (3.25%), some oxygen (1.36%) and low sulfur (0.27%). It is known that a significant amount of nitrogen is present in pyrrolic form and capable of participating in reactions. FIG. 2 is an example reaction of a pyrrole reacting with a ketone in the presence of an acid to form a porphyrinogen, which may be further oxidized to form a porphyrin. Similar reactions may be caused to take place within or using asphaltites according to aspects of the present disclosure. Asphaltites also include oxygen-containing molecules and sulfur or sulfur-containing molecules of aromatic, cyclic, and aliphatic compounds and may include complex structures of alcohols, phenols, aldehydes, ketones, esters, carboxylic acids, and such naturally derived molecules may include nitrogen-functionalized terpenes with chemical functionality including isocyanides, isothiocyanates, formamides, thiocyanates, isocyanates, dichloroimines, and the like. Such molecules may include phenylisocyanates and esters. FIG. 3 illustrates some such molecules believed to be present within asphaltites.

One or more aspects of the present disclosure aim to take advantage of the unique chemistry of asphaltites. In one example, a method includes modifying an asphaltite or portion(s) of asphaltite (such as pyrroles, porphyrins, and/or other nitrogen-containing polar resins) with an acid modifier. Polyphosphoric acid (PPA) has known characteristics when used in asphalt binders. In this example, polar resins of asphaltite become activated via PPA and are available for further reaction. Other usable acids may include diprotic organic acids. Additionally, strong acids (e.g., hydrochloric acid) may be used, although the degree of polymerization or cross-linking (as can be observed via rheological properties such as viscosity increases) may be less than with a multiprotic acid, as multiprotic acids such as polyphosphoric acid are believed to participate in polymerization and cross-linking reactions. Other usable acids may include single or multiprotic inorganic or organic acids with a pKa in the range of PPA. The extent and degree of activation may be different than PPA, so the extent and degree of polymerization or cross-linking (as can be observed via rheological properties such as viscosity increases) may be unique to each acid, as they may have unique dissociation, polarity, and hydrophobic/hydrophilic balance in particular systems of asphalts and additives. In this example, acids are used to activate asphaltite and to form new bonds or molecular interactions, adducts, crosslinking, or polymerization with polyethylene-vinyl acetate PVA copolymers. In a second example, asphaltite is activated using PPA to react with alkene-containing polymers (such as crumb rubber from waste tires or polymers like SBS or SBR). The resulting compositions are unique and exhibit surprisingly transformed rheological characteristics and other physical properties. In another additional or alternative example, nitrogen-containing polar resins of asphaltite (such as pyrroles, porphyrins, and the like), become activated and are available for further reaction. In a specific example, the asphaltite is gilsonite. The resulting compositions are unique and surprisingly exhibits transformed characteristics and properties.

In one example aspect of the present disclosure, a composition comprising an asphaltite that may be useful as a binder in asphalt pavement, a coating system for a paved asphalt surface, and the like is provided. Compositions according to the present disclosure may include an asphalt cement combined with asphaltite to form an asphalt blend.

In another aspect according to the present disclosure, a composition may include an asphalt blend comprising asphaltite. The asphaltite may be modified to possess a positive charge at least on a portion of the asphaltite (such as a nitrogen-containing polar resin). The asphaltite may be modified to possess a positive charge by a modifier. A modifier may be an acid, such as polyphosphoric acid, hydrochloric acid, a multiprotic organic acid, or a strong acid. Optional alternative or additional components may include one or more polymers and/or a rheology modifier. A rheology modifier may be a Fischer Tropsch wax. A polymer may be a crumb rubber or devulcanized crumb rubber. It is believed that numerous other polymers may be used additionally or alternatively.

In another aspect according to the present disclosure, using polyphosphoric acid, hydrochloric acid, a multiprotic organic acid, or a strong acid may modify the asphaltite or parts thereof (such as nitrogen-containing polar resins) to possess a positive charge. A multiprotic acid like polyphosphoric acid may also be available as a further activator for the asphaltite modified to possess a positive charge and may enable cross-linking, polymerization, dimerization, or adduction reactions.

In another aspect according to the present disclosure, a method of manufacturing an asphalt containing asphaltite modified to possess a positive charge, wherein the asphaltite is activated and polymerized, is provided. The method may include blending an asphalt cement with asphaltite to form an asphalt blend. The method may further include combining the asphalt blend with an acid to form an activated asphaltite, thereby allowing for chemical reactions including associations, covalent bonding, cross linking, polymerizations (including epoxy and urethane). The method may also include adding one or more polymers to the blend. This method may also include adding one or more asphalt rheology modifiers.

In an example, asphaltite may be retained as an asphalt (i.e., not a fraction, distillate, or derivative), and a modifier such as an acid may impart a charge on one or more nitrogen-containing moieties or polar resins (including pyrroles).

In one aspect, by modifying the asphaltite-asphalt blend to an excited protonated state via presence of a modifier, such as an acid, one or more nitrogen moieties (such as in the pyrroles and other aromatic rings, and also in isocyanate configurations) may become activated and available for further reactions (e.g., oxidation reactions) and associations. These various asphaltite chemical moieties may also be caused to react via epoxy and urethane reactions and polymerizations. Such reactions may be with molecules and moieties within the asphaltite, with molecules and moieties within the asphalt cement, or with molecules and moieties within an added polymer. Such reactions may occur through Mannich type reactions or similar reaction mechanisms.

Thus, portions of the asphaltite can be activated and react and form unique new improved molecules which provide for beneficial properties.

Compositions according to the present disclosure exhibit a surprising and significant phase change, not attained by any other previously known method of modification, indicative of complete reaction (including cross-linking, polymerizations, acid/base epoxy-like reactions such as alcoholysis and possible urethane reactions) of available reactive asphaltite moieties. Thus, surprising results have been further evidenced by a reduction of polar resins and significant changes in physical properties. Table 3 below lists example property changes.

One example composition according to the present disclosure is (percentages by weight of the composition):

Polyphosphoric acid (0.75%), crumb rubber (5.0%), Fischer Tropsch wax (3.0%), gilsonite (as the asphaltite) (18.0-20.0%), and asphalt cement performance grade 58-28 (balance).

The foregoing composition is represented as Sample 7 in Tables 3-4.

It is believed that in aspects of the present disclosure, the asphaltite resin has reacted either substantially or completely with all available moieties from the dissolved devulcanized crumb rubber (e.g., polyisoprene, polybutadiene, SBS, SBR, or polyethylene-vinyl acetate) as well as moieties in the asphalt composition, following the polyphosphoric acid activator, forming larger cross-linked and/or polymerized molecules. It is believed that the polyphosphoric acid may reduce the pH of the system to activate the nitrogen-containing moieties (like pyrroles and porphyrins) to possess a positive charge, in addition to acting as a cross-linking component. It is further believed that other acids, such as hydrochloric acid, a multiprotic organic acid, or a strong acid, would sufficiently activate the nitrogen-containing moieties in the asphalt composition to still allow for cross-linking to occur among moieties in the asphalt composition, between asphalt components and incorporated polymers, or both. In contrast to conventional polymer-modified asphalt cement or asphalt emulsions, compositions according to aspects of the present disclosure are believed to integrate polymer (such as crumb rubber) entirely into the continuous phase of the asphalt blend (which may comprise asphalt cement and asphaltite), better align properties like glass transition temperatures, and exhibit a surprising phase change. When the foregoing components were combined together at elevated temperatures (˜275 degrees Fahrenheit), a significant and surprising phase change occurred resulting in a thermosetting-like elastomeric composition with unique notable properties in part such as a reasonable increase in softening point; a large magnitude increase in rotational viscosity; a lower penetration; a greatly improved elastic recovery; a lower ductility; altered SARA fractions expected to improve performance in certain applications (such as in pavement or as a coating for pavement); a significant increase in G*/sin 8; a significant reduction in phase angle, 8; a significant change in Multiple Stress Creep Recovery, or MSCR, score; and resistance to changes on aging.

TABLE 3

| | | | Sample | | | | | | |
|---|---|---|---|---|---|---|---|---|---|
| | | | 1 | 2 | 3 | 4 | 5 | 6 | 7 |
| Asphalt | | | X | X | X | X | X | X | X |
| Binder | | | | | | | | | |
| Gilsonite | | | | X | X | X | X | | X |
| Fischer | | | | | X | X | X | X | X |
| Tropsch | | | | | | | | | |
| wax | | | | | | | | | |
| Polymer | | | | | | X | | X | X |
| PPA | | | | | | | X | X | X |
| | ASTM | Temp. | | | | | | | |
| Test | # | (° C.) | | | | | | | |
| Softening | D36-95 | | 42 | 67 | 88 | 87 | 89 | 58 | 111 |
| Point ° C. | | | | | | | | | |
| Rotational | D4402-13 | 135 | 248 | 1503 | 1272 | 2456 | 2040 | 1434 | 7070 |
| Viscosity | | | | | | | | | |
| 135° C. | | | | | | | | | |
| Penetration | D5-06 | 25 | 110 | 19 | 14 | 12 | 19 | 54 | 9 |
| 25° C., dmm | | | | | | | | | |
| Elastic | D6084-21 | 25 | 14 | 43 | 25 | 60 | 28 | 63 | 54 |
| Recovery | | | | | | | | | |
| % 25° C. | | | | | | | | | |
| Procedure A | | | | | | | | | |
| Ductility ° C. | D113-17 | 25 | 150 | 63 | 8 | 4 | 11 | 19 | 4 |
| Saturates % | tlc-fid | | 8 | 3 | 7 | 6 | 6 | 7 | 6 |
| Aromatics % | tlc-fid | | 56 | 42 | 39 | 37 | 33 | 48 | 39 |
| Resins % | tlc-fid | | 23 | 40 | 41 | 36 | 32 | 24 | 29 |
| Asphaltenes % | tlc-fid | | 13 | 15 | 13 | 21 | 29 | 21 | 26 |
| G*/sin δ, | D7175-15 | 52 | 3 | 102 | 121 | 203 | 106 | 20 | 508 |
| kpa | | | | | | | | | |
| Phase | D7175-15 | 52 | 86 | 69 | 67 | 61 | 63 | 63 | 47 |
| Angle, δ, | | | | | | | | | |
| deg | | | | | | | | | |
| 3.2 kpa, | D7405-20 | 52 | 3.13 | 0.054 | 0.0256 | 0.0095 | 0.0158 | 0.1912 | 0.0003 |
| kpa | | | | | | | | | |
| 3.2 kpa, | D7405-20 | 58 | 7.39 | 0.1606 | 0.0852 | 0.0278 | 0.0422 | 0.5793 | 0.0007 |
| kpa | | | | | | | | | |
| 3.2 kpa, | D7405-20 | 64 | 15.99 | 0.4484 | 0.246 | 0.0897 | 0.1222 | 1.5289 | 0.0013 |
| kpa | | | | | | | | | |
| 3.2 kpa, | D7405-20 | 70 | 30.69 | 1.1738 | 0.7167 | 0.2676 | 0.3601 | 3.5864 | 0.0024 |
| kpa | | | | | | | | | |
| 3.2 kpa, | D7405-20 | 76 | 53.44 | 2.7999 | 1.8844 | 0.8007 | 1.1102 | 7.3333 | 0.0058 |
| kpa | | | | | | | | | |

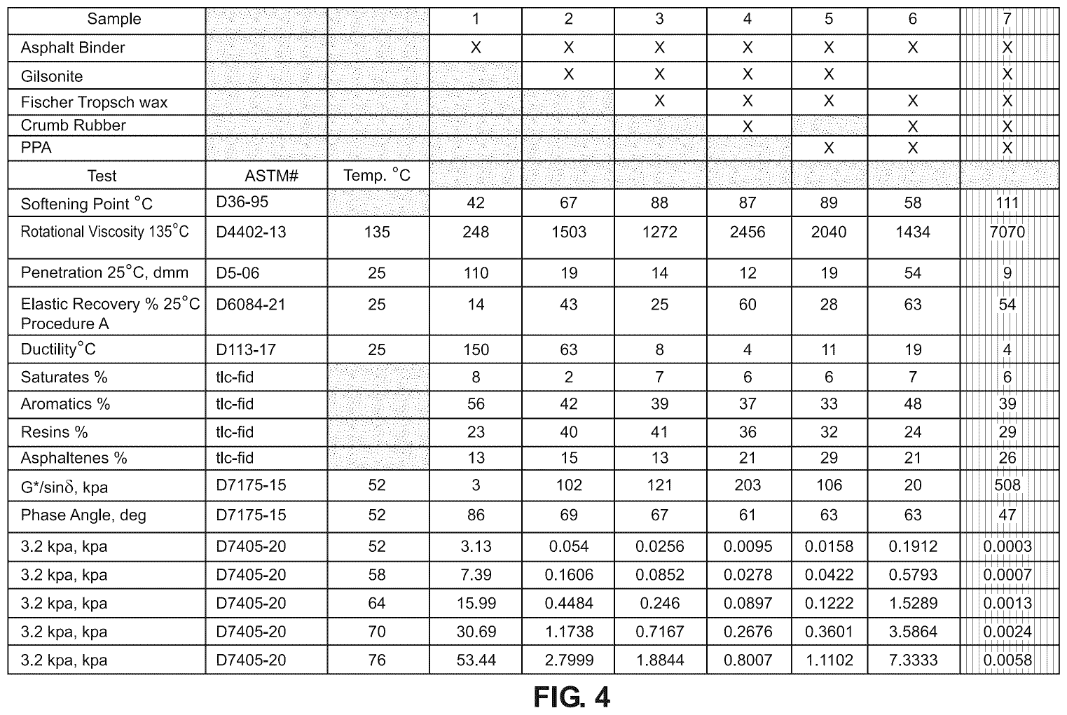

A larger version of Table 3 is included as FIG. 4.

To confirm the findings, Samples 1-7 were recreated and retested for additional rheological properties. This data is included in Table 4 below.

TABLE 4

| | ASTM | Temp | Sample Number | | | | | | |
|---|---|---|---|---|---|---|---|---|---|
| Test | Method | ° C. | 1 | 2 | 3 | 4 | 5 | 6 | 7 |
| Softening Point ° C. | D36-95 | | 42 | 57.8 | 88.4 | 87.3 | 89 | 58 | 94.1 |
| Rotational Viscosity 135° C. | D4402-13 | 135 | 257 | 832 | 1272 | 2456 | 2040 | 1434 | 7781 |
| Penetration 25° C., dmm | D5-06 | 25 | 104 | 32 | 14 | 12 | 19 | 54 | 16 |
| Elastic Recovery % 25° C. | D6084-21 | 25 | 14 | 34 | 25 | 60 | 28 | 63 | 53 |
| Procedure A | | | | | | | | | |
| Saturates % | IP-469 | | 7.18 | 4.51 | 6.84 | 6.32 | 6 | 7 | 4.55 |
| Aromatics % | IP-469 | | 56.23 | 43.29 | 38.91 | 37.09 | 33 | 48 | 41.88 |
| Resins % | IP-469 | | 23.59 | 37.95 | 41.03 | 35.96 | 32 | 24 | 29.79 |
| Asphaltenes % | IP-469 | | 12.99 | 14.25 | 13.22 | 20.63 | 29 | 21 | 23.78 |
| G*/sinδ, kpa Unaged | D7175-15 | 52 | 3.3293 | 26.5285 | 121.3627 | 202.6654 | 106 | 20 | 168.7824 |
| Phase Angle, deg | D7175-15 | 52 | 86 | 75.1 | 67.5 | 61 | 63 | 63 | 57 |
| Unaged | | | | | | | | | |
| 3.2 kpa, kpa Unaged | D7405-20 | 76 | 52.9828 | 9.0967 | 1.8844 | 0.8007 | 1.1102 | 7.3333 | 0.1807 |

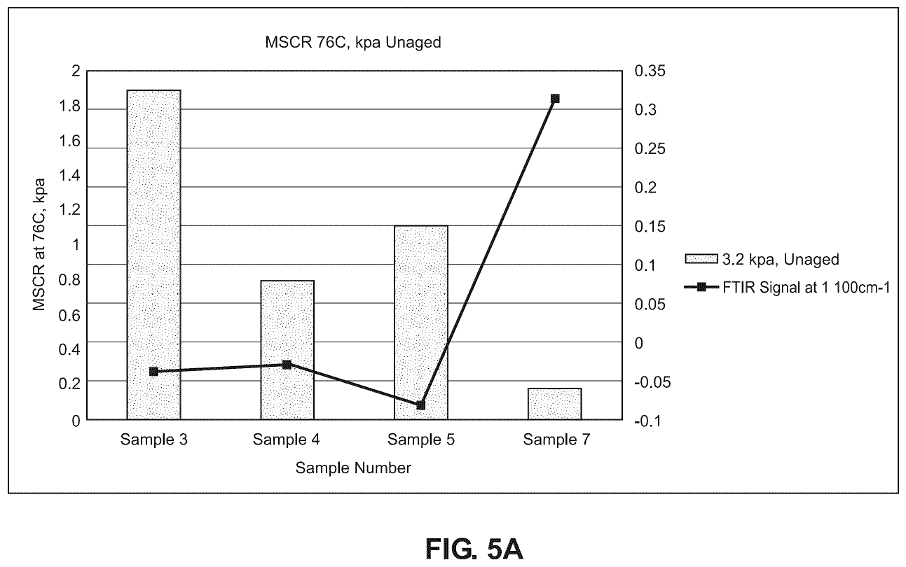

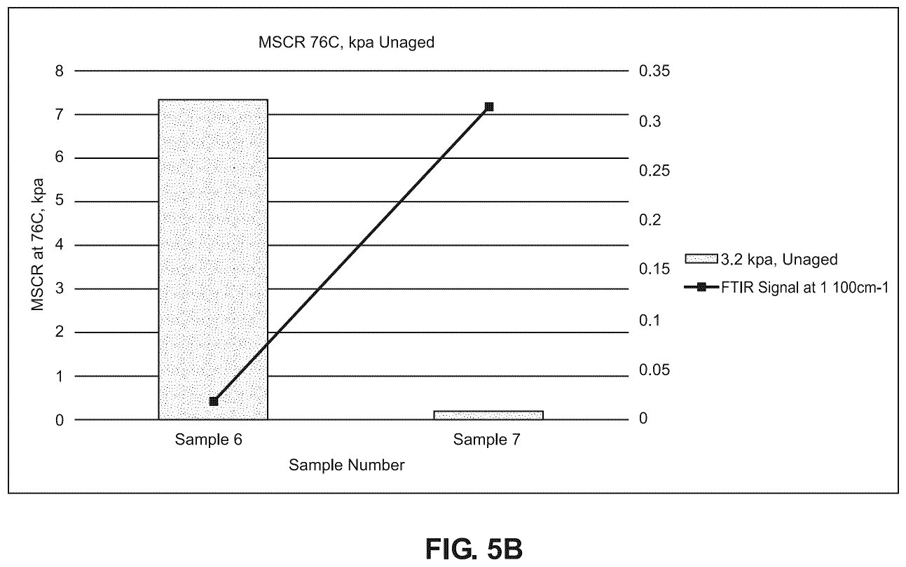

Additionally, Fourier transform infrared (“FTIR”) spectroscopy analysis of the components and blended compositions supports the rheological results showing reactions, likely cross-linking and polymerization, and phase changes of the composition. As seen in FIGS. 5A (showing samples 3-5 and 7) and 5B (showing samples 6 and 7), a sharp change in rheological properties indicative of crosslinking or polymerization appears in the asphalt-gilsonite-polymer blend of Sample 7, reflected by the appearance of a new FTIR signal at 1100 cm-1. The MSCR (multiple stress creep recovery) parameter measured at 76° C. for all samples with polymer show reduced sensitivity to creep, indicating the presence of gilsonite or polymer. However, only Sample 7 with polymer, gilsonite, and acid signifies formation of C—O—C moieties (covalent bonds of carbon-oxygen-carbon) in the blend, signified by the FTIR peak at 1100 cm-1, which confirms a polymerization or cross-linking reaction occurring in the asphalt-gilsonite-polymer composition. The data shows the following: a decrease in aromatics, an increase in asphaltenes, a G*/sin 8 increase, a decrease in phase angle 8, and a more favorable MSCR test result at 76° C. showing greater viscoelasticity. A table of the FTIR and MSCR data (which is graphed in FIGS. 5A-5B) is shown below:

TABLE 5

| | FTIR Data | No Baseline | Baseline | |
|---|---|---|---|---|
| | Unaged | Correction | Corrected | MSCR@76 C. |
| C-O-C Stretch Spectral Region | | | | X |
| 1135-1045 cm−1 | | | | X |
| | Sample 1 | −0.0331 | 0 | 12.3266 |
| | Sample 2 | −0.0428 | 0 | 1.0681 |
| | Sample 3 | −0.0373 | 0 | 0.1306 |
| | Sample 4 | −0.0294 | 0 | 0.0417 |
| | Sample 5 | −0.0823 | 0 | 0.5258 |
| | Sample 6 | 0.0171 | 0.0171 | 0.0585 |
| | Sample 7 | 0.3139 | 0.3139 | 0.0201 |

The foregoing demonstrates that at least one example composition according to the present disclosure (reflected, as just one example, in Sample 7 of Table 3) underwent a phase change and resulted in a significant improvement with respect to certain ASTM/AASHTO tests used in paving and asphalt coatings. It is believed that such a phase change may be obtainable with other compositions, such as other polymers than crumb rubber or polyethylene, with other asphaltites instead of gilsonite, and without Fischer Tropsch wax or with other types of rheology modifiers. It is believed that the asphaltite-modified asphalt cement, combined with a polymer additive, as well as a modifier such as polyphosphoric acid or hydrochloric acid (and likely other strong acids and multiprotic organic acids), will exhibit similar phase changes.

One surprising attribute about asphalt compositions made according to the present disclosure is that, despite an increase in certain rheological properties, elasticity also increases, likely due to the ability to increase the amount of polymer in the system beyond what was previously possible. Another surprising attribute is anti-aging qualities. It is believed that the polymerization or cross-linking of asphalt, asphaltite, and polymer involves the covalent bonding of moieties in asphalt capable of being oxidized, such that they are no longer available to be oxidized. As a result, asphalt compositions are far less capable of age-related pavement failures compared to existing asphalt compositions.

Fischer Tropsch wax may be an optional additive. Fischer Tropsch wax is a hard, wax-like component that acts on one hand as a “lubricant” (when temperatures are above the transition trigger, like glass transition Tg) and on the other hand (temperature below the trigger) hardens up (in a phase change). One aspect of the present disclosure includes using the Sample 7 composition in a warm mix asphalt, which may utilize Fischer Tropsch wax in asphalt compositions to lower the useful working temperature of the asphalt mix. The inclusion of gilsonite or other asphaltite may stiffen the asphalt composition and increase the softening point (and other effects) and may require higher temperatures to be fluid, so the addition of Fischer Tropsch wax helps to lower the fluidity temperature of the asphalt composition blend comprising asphaltite. However, it is believed that cross-linking among the asphalt-asphaltite composition and incorporated polymer or other additives will still take place without adding Fischer Tropsch wax or another waxy additive.

Utilizing the foregoing concepts to polymerize or cross-link asphaltite-modified asphalt with polymer that has been taken into the asphalt phase allows for the use of a much wider array of additives, and altering the amounts of asphaltite, polymers, and other additives allows for a wide variety of products to be tuned to a much higher degree than previously known. Numerous other monomers, polymers, and cross-linking agents can be drawn into the asphalt phase and reacted.

The reactions described herein utilize nitrogen atoms present in reactive moieties in asphaltite (such as porphyrins and pyrroles) to cause polymerization, cross-linking, or both among the asphaltite-modified asphalt and added monomers or polymers. Covalent bonding and other molecular interactions of polymer with the asphaltite draws the polymer into the asphalt phase. In other words, the polymer can be thought of as being solvated, integrated, or otherwise associated into the asphalt phase. By varying the amounts of asphaltite and polymer (or monomers, or other additives), the reaction would be expected to attain different rheological results. Specific results can be obtained empirically. Existing specifications that typically require significant polymer additives, which have historically caused stability issues, can be met using less polymers or polymers thought to be incompatible. Since the polymers are taken into the asphalt phase and reacted, the ability of the polymer to react unfavorably with aspects of the system is significantly lessened or removed. Additionally, adding more polymer than previously thought possible can be done without causing prohibitive stability issues, which may allow one to push elasticity and durability farther than was previously attainable. Increased ability to use higher amounts of recycled materials may be realized.

The reactions are controllable by controlling the amounts of reactants in the system. The result is an asphalt that is more stable, can utilize different polymers, and can utilize more polymers for applications that desire it. It is believed that elastomers having an alkene (tire rubber or polyethylene PVA, for example) can be utilized, as well as acrylics. It is believed that polymers having tertiary carbons may also be utilized.

In examples, varying the amount of asphaltite allows the ability to tune the rheology of the resulting asphalt composition. Using less asphaltite provides less availability to react, which leads to a lower degree of cross-linking, polymerization, or similar molecular associations. This would result in relatively lower phase changes, compositional disuniformity, lower viscosities, and the like. Adding more asphaltite would cause a polymerization, cross-linking, or other similar associations to occur to a greater degree, and would allow more polymer or additives to be taken into the asphalt phase, resulting in a composition with more desirable rheological characteristics, and at the same time having a higher degree of desired elasticity.

For example, varying the amount of asphaltite may vary the effects of the reactions occurring in the system. Holding the other components of the system constant, the effects of varying the amount of asphaltite results in the stiffness of the composition to rise, and yet the elasticity of the composition also increases. Additional rheological changes are also observed. It will be appreciated that varying the amounts of other components of the system may also alter the properties of the asphalt composition, so by changing the amounts of the components of the system, the resulting asphalt compositions can effectively be tuned to meet certain properties or performance characteristics. Table 6 below shows data reflecting the effects of varying the amount of gilsonite, when used as the asphaltite, in the system:

TABLE 6
AC + variable rate of gilsonite + 5% Polymer

| | ASTM | | | |
|---|---|---|---|---|
| Unaged | method | 10% Gilsonite | 15% Gilsonite | 20% Gilsonite |
| Softening Point ° C. | D36-95 | 82.5 | 91.3 | 94.1 |
| Rotational Viscosity 135 C. | D4402-13 | 1448 | 1566 | 7781 |
| Penetration 25 C., dmm | D5-06 | 27 | 18 | 16 |
| Elastic Recovery %, 25 C. | D6084-21 | 26 | 30 | 37 |
| Procedure B | | | | |
| G*/sinδ, kpa, 52 C. | D7175-15 | 57.7795 | 98.7935 | 168.7824 |
| Phase Angle, deg, 52 C. | D7175-15 | 65.7 | 66.0 | 57.0 |

MSCR

| | | | | |
|---|---|---|---|---|
| 3.2 kpa, kpa, 52 C. | D7405-20 | 0.0416 | 0.0283 | 0.004 |
| 3.2 kpa, kpa, 58 C. | D7405-20 | 0.1225 | 0.0769 | 0.0104 |
| 3.2 kpa, kpa, 64 C. | D7405-20 | 0.3365 | 0.2467 | 0.0226 |
| 3.2 kpa, kpa, 70 C. | D7405-20 | 1.1221 | 0.6571 | 0.0611 |
| 3.2 kpa, kpa, 76 C. | D7405-20 | | 1.9149 | 0.1807 |

Aged

| | | | | |
|---|---|---|---|---|
| Softening Point C. | D36-95 | 92.4 | 91.6 | 104.5 |
| Rotational Viscosity 135 C. | D4402-13 | 4583 | 4883 | 38583 |
| Penetration 25 C., dmm | D5-06 | 14 | 11 | 12 |
| Elastic Recovery %, 25 C. | D6084-21 | 45 | 44 | 45 |
| Procedure A | | | | |
| G*/sinδ, kpa, 52 C. | D7175-15 | 214.5016 | 346.1321 | 438.5283 |
| Phase Angle, deg, 52 C. | D7175-15 | 55.8 | 57.9 | 50.9 |

MSCR

| | | | | |
|---|---|---|---|---|
| 3.2 kpa, kpa, 52 C. | D7405-20 | 0.0033 | 0.0033 | 0.0006 |
| 3.2 kpa, kpa, 58 C. | D7405-20 | 0.0093 | 0.0087 | 0.0015 |
| 3.2 kpa, kpa, 64 C. | D7405-20 | 0.0221 | 0.0243 | 0.0034 |
| 3.2 kpa, kpa, 70 C. | D7405-20 | 0.0683 | 0.0639 | 0.0075 |
| 3.2 kpa, kpa, 78 C. | D7405-20 | 0.1876 | 0.2245 | 0.0201 |

Similarly, varying the amount of polymer or other additives added to the system is expected to have the same or similar effects, since the additives react with the acid-activated asphaltite stoichiometrically. Using less polymer or additive would be expected to provide less available molecular sites to react or associate, which leads to a lower degree of cross-linking, polymerization, or similar interactions. This would result in relatively lower phase changes, lower viscosities, and the like. Adding more polymer would cause a polymerization or cross-linking reaction to occur to a greater degree, resulting in a thicker product with stiffer rheological characteristics and at the same time having a higher degree of elasticity.

In another example, varying the amount of polymer present in the reactive system can affect the properties of the resulting asphalt compositions. At 300° F. blending parameters, as the percent polymer is increased, the compositional Penetration, Softening Point, Viscosity, and Phase Angle also increase (indicating increasing “stiffness”), yet surprisingly the elasticity properties significantly increase regarding desirable characteristics. Surprisingly, at 350° F. blending, instead of the polymer degrading, the positive effect is even more enhanced (showing a 2× to 5× increase in desired elasticity properties). Table 7 shows data reflecting the foregoing:

TABLE 7

| | | AC + 20% gilsonite various Polymer rates | | | | | | | |
|---|---|---|---|---|---|---|---|---|---|
| | ASTM | 0% | 0.5% | 1% | 1.25% | 1.5% | 1.75% | 2.5% | 3% |
| Test | Method | EVA | EVA | EVA | EVA | EVA | EVA | EVA | EVA |
| 300 F. | | | | | | | | | |
| blending | | | | | | | | | |
| Penetration 25 C., | D5-06 | 38 | 35 | 40 | 35 | 31 | 30 | 36 | 29 |
| dmm | | | | | | | | | |
| Softening | D36-95 | 55.7 | 57.9 | 58.4 | 58 | 58.7 | 59 | 60.6 | 61.6 |
| Point C | | | | | | | | | |
| Rotational | D4402-13 | 873 | | 1131 | 1197 | | | 1762 | |
| Viscosity, | | | | | | | | | |
| 135 C. | | | | | | | | | |
| Elastic | D6084-21 | 13 | 39 | 49 | 52 | 53 | 54 | 60 | 64 |
| Recovery | | | | | | | | | |
| %, 25 C. | | | | | | | | | |
| Procedure B | | | | | | | | | |
| G*/sinδ, | D7175-15 | 24.3644 | 27.9243 | 25.2159 | 25.9537 | 28.9423 | 31.0475 | 29.9850 | 35.1116 |
| kpa, 52 C. | | | | | | | | | |
| Phase | D7175-15 | 74.9 | 73.8 | 73.3 | 73.0 | 72.1 | 71.7 | 70.5 | 68.9 |
| Angle, | | | | | | | | | |
| deg, 52 C. | | | | | | | | | |
| MSCR | | | | | | | | | |
| 3.2 kpa, | D7405-20 | 0.2746 | 0.2086 | 0.1621 | 0.2072 | 0.1665 | 0.1557 | 0.1350 | 0.1013 |
| kpa, 52 C. | | | | | | | | | |
| 3.2 kpa, | D7405-20 | 0.7621 | 0.5932 | 0.4815 | 0.5760 | 0.4689 | 0.4441 | 0.3841 | 0.2723 |
| kpa, 58 C. | | | | | | | | | |
| 3.2 kpa, | D7405-20 | 1.9164 | 1.4960 | 1.2234 | 1.4621 | 1.2827 | 1.2179 | 0.9974 | 0.7776 |
| kpa, 64 C. | | | | | | | | | |
| 3.2 kpa, | D7405-20 | 4.4089 | 3.5915 | 3.0527 | 3.4659 | 3.0689 | 2.9522 | 2.6709 | 2.0003 |
| kpa, 70 C. | | | | | | | | | |
| 3.2 kpa, | D7405-20 | 9.5914 | 7.8769 | 6.7787 | 7.5597 | 6.7266 | 6.4431 | 5.6417 | 4.4500 |
| kpa, 76 C. | | | | | | | | | |
| 350 F. | | | | | | | | | |
| blending | | | | | | | | | |
| Penetration 25 C., | D5-06 | 17 | 16 | 15 | | | 15 | 18 | 14 |
| dmm | | | | | | | | | |
| Softening | D36-95 | 72.4 | 73.0 | 73.0 | | | 75.7 | 76.3 | 77.4 |
| Point C | | | | | | | | | |
| Rotational | D4402-13 | 2756 | | | | | | 4620 | |
| Viscosity | | | | | | | | | |
| 135 C. | | | | | | | | | |
| Elastic | D6084-21 | 17 | 29 | 44 | | | 51 | 58 | 61 |
| Recovery | | | | | | | | | |
| %, 25 C. | | | | | | | | | |
| Procedure B | | | | | | | | | |
| G*/sinδ, | D7175-15 | 140.1520 | 158.4723 | 138.8892 | | | 161.8780 | 166.0361 | 183.7357 |
| kpa, 52 C. | | | | | | | | | |
| Phase | D7175-15 | 62.5 | 61.1 | 61.6 | | | 59.9 | 58.7 | 58.4 |
| Angle, | | | | | | | | | |
| deg, 52 C. | | | | | | | | | |
| MSCR | | | | | | | | | |
| 3.2 kpa, | D7405-20 | 0.0157 | 0.0111 | 0.0148 | | | 0.0111 | 0.0093 | 0.0078 |
| kpa, 52 C. | | | | | | | | | |
| 3.2 kpa, | D7405-20 | 0.0524 | 0.0336 | 0.041 | | | 0.0298 | 0.0246 | 0.0185 |
| kpa, 58 C. | | | | | | | | | |
| 3.2 kpa, | D7405-20 | 0.1322 | 0.0959 | 0.1201 | | | 0.0832 | 0.0642 | 0.0468 |
| kpa, 64 C. | | | | | | | | | |
| 3.2 kpa, | D7405-20 | 0.4223 | 0.2823 | 0.3553 | | | 0.2324 | 0.1746 | 0.135 |
| kpa, 70 C. | | | | | | | | | |
| 3.2 kpa, | D7405-20 | 1.1209 | 0.7453 | | | | 0.6368 | 0.5386 | 0.3384 |
| kpa, 76 C. | | | | | | | | | |

Historically, it was difficult to incorporate any polymer into an asphalt system to levels above 7% by weight of the asphalt product composition. Polymer loadings above 3% often exhibited stability and incompatibility issues to a disadvantageous degree. Now, such polymer loadings of about 7% by weight of the asphalt product composition can be attained without stability or incompatibility issues, and it is believed that the amount of polymer can be increased to about 15% by weight of the asphalt product composition. This further allows the rheological properties of the asphalt product to be controlled to a much higher degree than previously possible.

The products can be further altered and tuned with other additives such as maltene oil rejuvenators, waxes, and the like.

Additionally, it is believed that compositions according to the present disclosure may be effectively heat activated. Even in the presence of an acid activator (HCl), the combination of additives (asphalt binder, asphaltite, EVA polymer) shows some indications of mild reactions, complexations, and the like, via improvements to rheological characteristics in a uniform and predictable manner. However, the addition of heat (250° F. to 350° F.) to the composition results in significant changes to the rheology, indicating increased reactions, polymerizations, complexations, bonding, crosslinking, and the like. Table 8 below shows the effect of heat on compositions according to the present disclosure:

TABLE 8
Testing on Adduct Composition (AC + 20% gilsonite +
2.5% EVA polymer): with and without

| | | No | | Increase | % |
|---|---|---|---|---|---|
| Test Method | Description | Heat | Heat | with Heat | Increase |
| T49 | Penetration, | 52.7 | 53.7 | 1.0 | — |
| (AASHTO) | 4 C., dmm | | | | |
| T301 | Elastic Recovery, | 75.0 | 82.5 | 7.5 | 10% |
| (AASHTO) | 25 C., % | | | | |
| T51 | Ductility, | 57.0 | 72.0 | 15.0 | 26% |
| (AASHTO) | 4 C., mm | | | | |
| D5801 | Toughness, | 86.2 | 129.3 | 43.1 | 50% |
| (ASTM) | 25 C., in-lbs | | | | |
| D5801 | Tenacity, | 69.7 | 117.1 | 47.4 | 68% |
| (ASTM) | 25 C., in-lbs | | | | |

Using reactions according to the disclosure, it is expected that an asphalt composition can be made to order. In other words, if one desires an asphalt composition to have certain specified characteristics and properties, then it can be tuned to meet those specifications. Similarly, favorable additives can be incorporated to a degree not possible before.

It is believed that the application of heat to compositions according to the present disclosure significantly increases the degree to which the system undergoes reaction and forms an asphalt composition exhibiting significantly changed rheological properties. The amount of heat to effectively cause the reaction to progress has been found to be between about 250° F. to about 350° F.

It is within the scope of the disclosure to apply asphalt compositions in multi-stream systems, where multi-component reactants and additives are fully combined only at the desired application site. This allows for the products to be transported without reaction before the product arrives at the desired location, and also allows for the ability to control properties in final composition as it is placed or otherwise used, which leads to better control of final desired properties. In a multi-stream application for pavements, the polymerization and cross-linking reactions occur as it is applied to a pavement or to form a pavement. This can also allow for a composition having a much higher viscosity and elasticity than previously possible to be applied into or onto the pavement. Utilizing a multi-stream application process may allow for control of desired final properties of the composition such as strength, cohesion, and the use of different polymers than was possible before. Aspects according to the present disclosure may be implemented in the following example products.

Hot-Mix Asphalt. One aspect of the present disclosure includes asphalt paving compositions for use in new hot-mix asphalt (HMA) mixes comprising a asphaltite-asphalt-polymer mixture that has been combined with a multiprotic acid or strong acid so that the mixture has undergone a polymerization, adduction, or cross-linking reaction. The reacted mixture is included as a binder at between about 4% to about 9% of the total HMA composition by weight, mixed in a hot-mix plant with coarse and fine aggregate (which may include recycled asphalt product (RAP) or other additives) at temperatures in the range of 300 F to 400 F. The result is an HMA having improved strength, durability, age resistance, sustainability, and resilience. HMA compositions may allow an asphalt binder to meet minimum performance requirements using lower levels of additives and increase an asphalt binder's performance characteristics to allow for thinner asphalt pavement sections while still meeting minimum structural requirements. Other benefits may include mitigation of drain down, a greater use of dense grade asphalt mixtures and pavements, a more stable and compatible asphalt binder, and the use of hybrid polymer systems.

Yet another HMA embodiment utilizes a two-stream aspect of the innovation, comprising a asphaltite-asphalt-polymer mixture that has not been combined with an activating acid as stream #1. As the mixture binder is piped from the holding tank into the Hot Mix mixing drum, the mixture is exposed to and combined and mixed with an acid activator via an in-line additive pipe (#2 stream) and associated apparatus, the resultant adduct composition included as a binder between about 4% to about 9% of the total HMA composition by weight, mixed in a hot-mix plant with coarse and fine aggregate (which may include recycled asphalt product (RAP) or other additives) at temperatures in the range of 300 F to 400 F. The result is an HMA having improved strength, durability, age resistance, sustainability, and resilience.

Yet another HMA embodiment utilizes a two-stream aspect of the innovation, comprising a asphaltite-asphalt-acid-activator mixture that has not been combined with a desired monomer or polymer additive, as stream #1. As the mixture binder is piped from the holding tank into the Hot Mix mixing drum, the mixture is exposed to and combined and mixed with a desired liquid monomer or polymer additive via an in-line additive pipe (stream #2) and associated apparatus, the resultant adduct composition included as a binder between about 4% to about 9% of the total HMA composition by weight, mixed in a hot-mix plant with coarse and fine aggregate (which may include recycled asphalt product (RAP) or other additives) at temperatures in the range of 300 F to 400 F. The result is an HMA having improved strength, durability, age resistance, sustainability, and resilience.

In a three-stream aspect, the asphaltite-asphalt mixture has not been combined with any other additive (as stream #1), and is introduced to the HMA plant mixing drum as would be a typical asphalt cement or binder; the other additives are introduced via in-line method as aforementioned. The desired liquid monomer or polymer additives can be introduced via in-line #1 (i.e. stream #2), and the acid activator via in-line #2 (i.e. stream #3), or combinations thereof.

Yet another HMA embodiment utilizes a asphaltite-asphalt-polymer-activator reacted adduct that has been extruded via a composite extrusion method and is available in a solid pellet form, said pellets being introduced to the HMA mix drum via addition to the aggregate feeding system, included as a binder between about 4% to about 9% of the total HMA composition by weight (similar to Ground Tire Rubber dry process in HMA).

Yet another HMA embodiment utilizes a asphaltite-polymer-activator reacted adduct (without asphalt cement) that has been extruded via a composite extrusion method and is available in a solid pellet form, said pellets being introduced to the HMA mix drum via addition to the aggregate feeding system, included as a binder between about 4% to about 9% of the total HMA composition by weight (similar to Ground Tire Rubber dry process in HMA).

Warm-Mix Asphalt. Another aspect of the present disclosure includes asphalt paving compositions for use in new warm-mix asphalt (WMA) mixes comprising a asphaltite-asphalt-polymer mixture that has been combined with a multiprotic acid or strong acid so that the mixture has undergone a polymerization, adduction, or cross-linking reaction. The reacted mixture is included as a binder at between about 4% to about 9% of the total WMA composition by weight of the total WMA composition, mixed in a hot-mix plant with coarse and fine aggregate (which may include recycled asphalt product (RAP) or other additives) at temperatures in the range of 225 F to 300 F. The result is a WMA having improved workability, strength, durability, age resistance, sustainability, and resilience. WMA compositions may allow an asphalt binder to meet minimum performance requirements using lower levels of additives and increase an asphalt binder's performance characteristics to allow for thinner asphalt pavement sections while still meeting minimum structural requirements. Other benefits may include mitigation of drain down, a greater use of dense grade asphalt mixtures and pavements, a more stable and compatible asphalt binder, and the use of hybrid polymer systems. Still other benefits may include reduced compaction levels, a pavement that is easier to compact to a certain (e.g., 95%) density, a pavement that requires less passes of a compactor, and a pavement that requires less time to compact (which may be important for certain applications, such as airfields).

Another aspect of the present disclosure includes asphalt paving compositions for use in new warm-mix asphalt (WMA) mixes utilizes a two-stream aspect of the innovation, comprising a asphaltite-asphalt-polymer mixture, including the addition of a Fisher Tropsch wax, that has not been combined with an acid activator, as stream #1. As the mixture binder is piped from the holding tank into the Hot Mix mixing drum, the mixture is exposed to and combined and mixed with an acid activator via an in-line additive pipe (stream #2) and associated apparatus. The reacted mixture is included as a binder at between about 4% to about 9% of the total WMA composition by weight of the total WMA composition, mixed in a hot-mix plant with coarse and fine aggregate (which may include recycled asphalt product (RAP) or other additives) at temperatures in the range of 225 F to 300 F. The result is a WMA having improved workability, strength, durability, age resistance, sustainability, and resilience.

In a three-stream aspect, the asphaltite-asphalt and Fisher Tropsch wax mixture has not been combined with any other additive (as stream #1), and is introduced to the WMA plant mixing drum as would be a typical asphalt cement or binder; the other additives are introduced via in-line method as aforementioned. The desired liquid monomer or polymer additives can be introduced via in-line #1 (i.e. stream #2), and the acid activator via in-line #2 (i.e. stream #3), or combinations thereof.

Yet another WMA embodiment utilizes a asphaltite-asphalt-polymer-activator reacted adduct, including Fisher Tropsch wax, that has been extruded via a composite extrusion method and is available in a solid pellet form, said pellets being introduced to the WMA mix drum via addition to the aggregate feeding system, included as a binder between about 4% to about 9% of the total WMA composition by weight (similar to Ground Tire Rubber dry process in HMA).

Yet another WMA embodiment utilizes a asphaltite-polymer-activator reacted adduct, including Fisher Tropsch wax, (without asphalt cement) that has been extruded via a composite extrusion method and is available in a solid pellet form, said pellets being introduced to the WMA mix drum via addition to the aggregate feeding system, included as a binder between about 4% to about 9% of the total WMA composition by weight (similar to Ground Tire Rubber dry process in HMA).

Cold In-place Recycling (CIR), Example 1. Another aspect of the present disclosure includes cold in place recycling of asphalt pavement using emulsions made from a asphaltite-asphalt-polymer mixture that has been combined with a multiprotic acid or strong acid so that the mixture has undergone a polymerization, adduction, or cross-linking reaction. In one example, an emulsion useful for cold in place recycling asphalt pavement includes the reacted asphaltite-asphalt-polymer mixture at an amount between about 50% to about 70% by weight of the emulsion, an emulsifying agent such as a surfactant at an amount of between about 1.0% to about 3.5% by weight of the emulsion, with the balance comprising water. Such an emulsion may be cationic, nonionic, anionic, or zwitterionic. Such an emulsion may be mixed into a pugmill of a cold-in-place recycling operation at a rate of about 2.5% to about 6% by total weight of the cold mix. Cold in place recycled asphalt pavement may exhibit improved strength, durability, age resistance, sustainability, and resilience.

Cold In-place Recycling (CIR), Example 2. Another aspect of the present disclosure includes cold in place recycling of asphalt pavement using a multi-stream application of an asphalt emulsion. In one example, a first stream of an emulsion may include a asphaltite-asphalt-polymer mixture at an amount between about 50% to about 70% by weight of the emulsion, an emulsifying agent such as a surfactant at an amount of between about 1.0% to about 3.5% by weight of the emulsion, with the balance comprising water. Such a first stream may be cationic, nonionic, anionic, or zwitterionic. A second stream and an optional third stream may include an acid (such as a strong acid or a multiprotic organic acid), a cross-linker (e.g., an isocyanate), additional polymer(s), or all of these, optionally mixed with water. The multi-stream emulsion may be mixed into the pugmill of a cold-in-place recycling operation in an amount of between about 2.5% to about 6% by total weight of the cold mix. The cold mix may be replaced as pavement, and the asphaltite-asphalt emulsion begins to react to internally polymerize, cross-link, or form adducts only once the two streams are combined. Such cold in place recycled asphalt pavement may exhibit improved strength, durability, age resistance, sustainability, and resilience. Such an approach may allow for better on-site control of pavement properties.

Cold In-place Recycling, Example 3. Another aspect of the present disclosure includes a cold in-place recycled (CIR) asphalt pavement utilizing the foam method. In one example, the CIR asphalt pavement utilizes a two-part system where a first part is a asphaltite-asphalt-polymer mixture heated to between about 225° F. to about 350° F., and a second part includes an acid (such as a strong acid or a multiprotic organic acid), a cross-linker (e.g., an isocyanate), or both mixed with water and an emulsifying agent. The composition is mixed into the pugmill of a CIR operation, via the “foam” method, in an amount of between about 2.5% to about 6% by total weight of the cold mix, then replaced as pavement. Such cold in place recycled asphalt pavement may exhibit improved strength, durability, age resistance, sustainability, and resilience.

Cold Central Plant Recycled Asphalt Pavement, Example 1. Another aspect of the present disclosure includes a cold central plant recycled (CCPR) asphalt pavement. In one example, asphalt paving compositions for use in CCPR asphalt pavement may include an emulsion including the reacted asphaltite-asphalt-polymer mixture at an amount between about 50% to about 70% by weight of the emulsion, an emulsifying agent such as a surfactant at an amount of between about 1.0% to about 3.5% by weight of the emulsion, with the balance comprising water. The composition may mixed into the pugmill of a CCPR operation in an amount between about 2.5% to about 6% by total weight of the cold mix, and replaced as pavement. Such a CCPR application may exhibit improved strength, durability, age resistance, sustainability, and resilience, and the ability to adjust the workability and performance characteristics of the mix to best suit the project's operations.

Cold Central Plant Recycled Asphalt Pavement, Example 2. Another aspect of the present disclosure includes a cold central plant recycled (CCPR) asphalt pavement using a multi-stream application of an asphalt emulsion. In one example, a first stream of an emulsion may include a asphaltite-asphalt-polymer mixture at an amount between about 50% to about 70% by weight of the emulsion at a temperature between about 225° F. to about 300° F., and a second stream may include an emulsifying agent such as a surfactant at an amount of between about 1.0% to about 3.5% by weight of the emulsion, an acid (such as a strong acid or a multiprotic organic acid), a cross-linker (e.g., an isocyanate), or both, with the balance comprising water. Such a second stream may be cationic, nonionic, anionic, or zwitterionic. The multi-stream emulsion may be mixed into the pugmill of a CCPR operation in an amount of between about 2.5% to about 6% by total weight of the cold mix. Such a CCPR application may exhibit improved strength, durability, age resistance, sustainability, and resilience, and the ability to adjust the workability and performance characteristics of the mix to best suit the project's operations.

Cold Mix Recycled Asphalt, Example 1. Another aspect of the present disclosure includes a cold mix recycled asphalt product. In one example, an asphalt emulsion may be used where the emulsion includes an asphalt-asphaltite-polymer mixture that has been combined with a multiprotic acid or strong acid so that the mixture has undergone a polymerization, adduction, or cross-linking reaction in an amount between about 50% to about 70% by weight of the emulsion, one or more emulsifying agents in an amount between about 1.0% to about 3.5% by weight of the emulsion, and the balance water. The emulsion may be mixed with aggregates (virgin or recycled asphalt aggregate) into the mixing drum of a hot-mix plant, in an amount between about 2.5% to about 9% by weight of total cold mix. In another example, the emulsion may be introduced to and mixed with aggregates that exist in a stockpile, via wheeled or tracked construction equipment, in an amount between about 2.5% to about 9% by weight of total cold mix.

Cold Mix Recycled Asphalt, Example 2. Another aspect of the present disclosure includes a cold mix recycled asphalt. In one example, an asphalt paving composition for use in cold mix may include an asphalt-asphaltite-polymer mixture that has been combined with a multiprotic acid or strong acid so that the mixture has undergone a polymerization, adduction, or cross-linking reaction in an amount between about 4% to about 9% by total weight of the cold mix, mixed in a hot-mix plant with coarse and fine aggregate, such as recycled asphalt product (RAP) and other additives and modifiers, at binder temperatures in the range of 225° F. to 300° F., to provide for cold mixes that show improved workability, strength, durability, age resistance, sustainability, and resilience.

Benefits of a cold mix using compositions according to the present disclosure may include allowing an asphalt binder to meet minimum performance requirements using lower levels of additives and increasing an asphalt binder's performance characteristics to allow for thinner asphalt pavement sections while still meeting minimum structural requirements. Other benefits may include mitigation of drain down, a greater use of dense grade asphalt mixtures and pavements, a more stable and compatible asphalt binder, and the use of hybrid polymer systems. Still other benefits may include reduced compaction levels, a pavement that is easier to compact to a certain (e.g., 95%) density, a pavement that requires less passes of a compactor, and a pavement that requires less time to compact (which may be important for certain applications, such as airfields).

Hot In Place Recycled Asphalt, Example 1. Another aspect of the present disclosure includes a hot in-place recycled (HIPR) asphalt pavement. In one example, an asphalt emulsion composition for use in HIPR includes an asphalt-asphaltite-polymer mixture that has been combined with a multiprotic acid or strong acid so that the mixture has undergone a polymerization, adduction, or cross-linking reaction in an amount between about 50% to about 70% by weight of the emulsion, one or more emulsifying agents in an amount between about 1.0% to about 3.5% by weight of the emulsion, and the balance water. The emulsion may be introduced into the HIP operation by spraying at a rate of between about 0.15 to about 0.30 gallons per square yard, after the pavement is heated and during re-mixing in place and prior to compaction. Such HIPR asphalt pavements may provide for improved workability, strength, durability, age resistance, sustainability, and resilience.

Hot In Place Recycled Asphalt, Example 2. Another aspect of the present disclosure includes a hot in-place recycled (HIPR) asphalt pavement. In one example, an asphalt paving composition for use in HIPR may include an asphalt-asphaltite-polymer mixture that has been combined with a multiprotic acid or strong acid so that the mixture has undergone a polymerization, adduction, or cross-linking reaction, at temperatures in the range of 225° F. to 300° F., introduced into the HIPR operation via spraying at a rate of between about 0.15 to about 0.30 gallons per square yard, after the pavement is heated and during re-mixing in place and prior to compaction. Such a composition may provide for HIPR mixes that show improved workability, strength, durability, age resistance, sustainability, and resilience.

Hot In Place Recycled Asphalt, Example 3. Another aspect of the present disclosure includes a hot in place (HIPR) recycled asphalt pavement. In one example, an HIPR asphalt pavement using a multi-stream application of an asphalt emulsion. In one example, a first stream of an emulsion may include a asphaltite-asphalt-polymer mixture at an amount between about 50% to about 70% by weight of the emulsion, an emulsifying agent such as a surfactant at an amount of between about 1.0% to about 3.5% by weight of the emulsion, and the balance water. A second stream may include water and an acid (such as a strong acid or a multiprotic organic acid), a cross-linker (e.g., an isocyanate), or both. Such a second stream may be cationic, nonionic, anionic, or zwitterionic. The emulsion may be introduced into the HIPR operation via spraying at a rate of between about 0.15 to about 0.30 gallons per square yard, after the pavement is heated and during remixing in place and prior to compaction. Such an asphalt emulsion may provide for HIPR mixes that show improved workability, strength, durability, age resistance, sustainability, and resilience.

Compositions according to the present disclosure may allow for HIPR applications that are heat-activated.

Warm Spray Surface Treatment, Example 1. Another aspect of the present disclosure includes a warm spray surface treatment. In one example, a warm spray-applied asphalt surface treatment composition for use in pavement maintenance and repair, such as chip seals, scrub seals, sand seals, stress absorbing membrane interlayer (SAMI) seals, and asphaltic high friction surface treatments (HFST), includes a asphaltite-asphalt-polymer mixture (and optionally a Fischer Tropsch wax) that has been combined with a multiprotic acid or strong acid so that the mixture has undergone a polymerization, adduction, or cross-linking reaction in an amount between about 50% to about 70% by weight of the composition, and optionally an oil or organic solvent. The composition may be at a temperature of between about 225° F. to about 300° F., applied via a computer-controlled spraying vehicle at rates of between about 0.10 to about 0.50 gallons per square yard, then covered with a layer of suitable aggregate. Such an asphalt composition may provide treatments with improved cure times, strength, durability, age resistance, sustainability, and resilience. In a second example, a hot spray surface treated may be provided using the foregoing composition at a temperature of between about 275° F. to about 350° F.

Warm Spray Surface Treatment, Example 2. Another aspect of the present disclosure includes a warm spray surface treatment in a multi-stream application. In one example, a warm spray-applied asphalt surface treatment composition for use in pavement maintenance and repair, such as chip seals, scrub seals, sand seals, stress absorbing membrane interlayer (SAMI) seals, and asphaltic high friction surface treatments (HFST), may include a two-part (or two stream) system. A first stream may include a asphaltite-asphalt-polymer mixture (and optionally a Fischer Tropsch wax), at a temperature of between approximately 225° F. to 300° F. A second stream may include a non-water-based stream containing a multiprotic acid or strong acid, applied via a computer-controlled spraying vehicle at rates of between about 0.10 to about 0.50 gallons per square yard, then covered with a layer of suitable aggregate. Such an asphalt composition may provide treatments with improved cure times, strength, durability, age resistance, sustainability, and resilience. In a second example, an additional third stream may contain additional liquid monomers or polymers. In a third example, a hot spray surface treated may be provided using the foregoing composition at a temperature of between about 275° F. to about 350° F.

Emulsion Spray Surface Treatment, Example 1. Another aspect of the present disclosure includes an emulsion spray surface treatment. In one example, a spray-applied asphalt surface treatment emulsion for use in pavement maintenance and repair, such as chip seals, scrub seals, sand seals, stress absorbing membrane interlayer (SAMI) seals, and asphaltic high friction surface treatments (HFST), may include a asphaltite-asphalt-polymer mixture that has been combined with a multiprotic acid or strong acid so that the mixture has undergone a polymerization, adduction, or cross-linking reaction asphaltite-asphalt-polymer mixture at an amount between about 50% to about 70% by weight of the emulsion, an emulsifying agent such as a surfactant at an amount of between about 1.0% to about 3.5% by weight of the emulsion, with the balance comprising water. The emulsion may be applied via a computer-controlled spraying vehicle at rates of between about 0.10 to about 0.50 gallons per square yard, then covered with a layer of suitable aggregate. Such an asphalt emulsion may provide treatments with improved cure times, strength, durability, age resistance, sustainability, and resilience.

Emulsion Spray Surface Treatment, Example 2. Another aspect of the present disclosure includes an emulsion spray surface treatment applied in a multi-stream system. In one example, a spray-applied asphalt surface treatment emulsion for use in pavement maintenance and repair, such as chip seals, scrub seals, sand seals, stress absorbing membrane interlayer (SAMI) seals, and asphaltic high friction surface treatments (HFST), may include a two-stream emulsion system. A first stream may include an asphalt-asphaltite-polymer mixture in an amount of between about 50% to about 70% by weight of the emulsion, one or more emulsifying agents in an amount between about 1.0% to about 3.5% by weight of the emulsion, and the balance water. A second stream may include water with a multiprotic acid or strong acid (and optionally an additive or cross-linker such as an isocyanate), applied via a computer-controlled spraying vehicle at rates of between about 0.10 to about 0.50 gallons per square yard, then covered with a layer of suitable aggregate. Such an asphalt emulsion may provide treatments with improved cure times, strength, durability, age resistance, sustainability, and resilience. In a second example, an additional third stream may contain additional liquid monomers or polymers.

In the foregoing examples, asphaltite may comprise about 20% of an asphalt-asphaltite mixture. It may be appreciated that the amount of asphaltite may be increased or reduced to tailor the product for a specific application. Altering the amount of asphaltite may cause the penetration of the asphalt product to be changed. Moreover, increasing the amount of asphaltite may allow additional cross-linking, polymerization, or adduction reactions to take place, which may affect the rheological properties of the asphalt application (e.g., an increased viscosity, a higher durability, a greater elasticity, etc.).

It will be appreciated by those skilled in the art that various modifications and alterations of the present disclosure can be made without departing from the broad scope of the appended claims. Some of these have been discussed above and others will be apparent to those skilled in the art. The scope of the present disclosure is limited only by the claims.

What is claimed is:

1. An asphalt composition, comprising:
a blend of an asphalt binder, asphaltite, and a polymer; and
an acid that is at least one of a strong acid or a multiprotic acid;
wherein the acid causes polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.

2. The asphalt composition of claim 1, further comprising a rheology modifier.

3. The asphalt composition of claim 2, wherein the rheology modifier is a Fischer Tropsch wax.

4. The asphalt composition of claim 1, wherein the polymer comprises at least one of tire rubber, SBS, SBR, vinyl acetate, HDPE, EPDM rubber, or methacrylate.

5. The asphalt composition of claim 4, wherein at least some of the polar resins in the asphaltite cross-link or polymerize with the polymer.

6. The asphalt composition of claim 4, wherein the acid is polyphosphoric acid.

7. The asphalt composition of claim 6, wherein at least some of the polar resins in the asphaltite cross-link or polymerize with the polyphosphoric acid and the polymer.

8. The asphalt composition of claim 1, wherein asphaltite is present in an amount between about 15% to about 30% by total weight of the blend, acid, and any additives.

9. The asphalt composition of claim 1, further comprising an isocyanate.

10. The asphalt composition of claim 1, wherein the acid is present in an amount of between about 0.50% to about 1.50% by total weight of the blend, acid, and any additives.

11. The asphalt composition of claim 1, wherein the blend exhibits an increase in stiffness and an increase in elasticity compared to the asphalt binder and the asphaltite alone.

12. A method of making an asphalt composition, comprising:
blending an asphalt binder, asphaltite, and a polymer to form a blend; and
adding an acid that is at least one of a strong acid or a multiprotic acid to the blend in an amount sufficient to cause polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.

13. The asphalt composition of claim 12, further comprising adding a rheology modifier.

14. The asphalt composition of claim 13, wherein the rheology modifier is a Fischer Tropsch wax.

15. The asphalt composition of claim 12, wherein the polymer comprises at least one of tire rubber, SBS, SBR, vinyl acetate, HDPE, EPDM rubber, or methacrylate.

16. The asphalt composition of claim 15, wherein at least some of the polar resins in the asphaltite cross-link or polymerize with the polymer.

17. The asphalt composition of claim 15, wherein the acid is polyphosphoric acid.

18. The asphalt composition of claim 17, wherein at least some of the polar resins in the asphaltite cross-link or polymerize with the polyphosphoric acid and the polymer.

19. The asphalt composition of claim 12, wherein asphaltite is present in an amount between about 15% to about 30% by total weight of the blend, acid, and any additives.

20. The asphalt composition of claim 12, further comprising adding an isocyanate.

21. The asphalt composition of claim 12, wherein the acid is added in an amount of between about 0.50% to about 1.50% by total weight of the blend, acid, and any additives.

22. The asphalt composition of claim 12, wherein the blend exhibits an increase in stiffness and an increase in elasticity compared to the asphalt binder and the asphaltite alone.

23. A pavement made from hot mix asphalt, comprising:
a mixture of an aggregate and an asphalt composition mixed at a temperature between about 300° F. and 400° F.;
wherein the asphalt composition constitutes between about 4% to about 9% of the total mixture by weight; and
wherein the asphalt composition comprises:
a blend of an asphalt binder, asphaltite, and a polymer; and
an acid that is at least one of a strong acid or a multiprotic acid;
wherein the acid causes polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.

24. A pavement made from warm mix asphalt, comprising:
a mixture of an aggregate and an asphalt composition mixed at a temperature between about 225° F. and 300° F.;
wherein the asphalt composition constitutes between about 4% to about 9% of the total mixture by weight; and
wherein the asphalt composition comprises:
a blend of an asphalt binder, asphaltite, and a polymer; and
an acid that is at least one of a strong acid or a multiprotic acid;
wherein the acid causes polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.

25. A cold mix recycled asphalt pavement, comprising:
a mixture of an aggregate comprising recycled pavement and an asphalt emulsion;
wherein the asphalt emulsion constitutes between about 2.5% to about 6% by total weight of the mixture;
wherein the asphalt emulsion comprises:
a blend of an asphalt binder, asphaltite, and a polymer, the blend in an amount of between about 50% to about 70% by weight of the emulsion;
an acid that is at least one of a strong acid or a multiprotic acid;
an emulsifying agent in an amount of between about 1.0% to about 3.5% of the emulsion; and
the balance water;
wherein the acid causes polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.

26. The cold mix recycled asphalt pavement of claim 25, wherein the asphalt emulsion is mixed with the aggregate using a multi-stream application of an asphalt emulsion, a first stream comprising the blend, the emulsifying agent, and water, and the second stream comprising the acid and water.

27. The cold mix recycled asphalt pavement of claim 25, wherein the asphalt emulsion is mixed with the aggregate in a single stream.

28. A warm spray surface treatment for an asphalt pavement, comprising:
spraying an asphalt composition heated to between about 225° F. to about 350° F. to a pavement by a controlled spraying vehicle at a rate of between about 0.10 to about 0.50 gallons per square yard, the asphalt composition comprising:
a blend of an asphalt binder, asphaltite, and a polymer; and
an acid that is at least one of a strong acid or a multiprotic acid;
wherein the acid causes polar resins in the asphaltite to be in an excited protonated state;
wherein the polymer comprises an alkene, ester, carbonyl, or alcohol moiety or is a urethane or an epoxy;
wherein the polymer is incorporated into the asphalt binder and the asphaltite such that the blend has a continuous, amorphous phase; and
wherein the blend exhibits at least one change to a rheological property compared to the asphalt binder and the asphaltite alone.
covering the sprayed pavement with an aggregate.

29. The warm spray surface treatment of claim 28, wherein the asphalt composition further comprises an oil or an organic solvent.

30. The warm spray surface treatment of claim 28, wherein the asphalt composition is an asphalt-in-water emulsion.
